(19) United States
(12) Patent Application Publication
(10) Pub. No.: US 2009/0179617 A1
(43) Pub. Date: Jul. 16, 2009

(54) BATTERY STATE MONITORING CIRCUIT AND BATTERY DEVICE

(76) Inventors: Toshiyuki Koike, Chiba-shi (JP); Atsushi Sakurai, Chiba-shi (JP); Kazuaki Sano, Chiba-shi (JP); Yoshihisa Tange, Chiba-shi (JP); Muneharu Kawana, Chiba-shi (JP)

Correspondence Address: BRINKS HOFER GILSON & LIONE, P.O. BOX 10395, CHICAGO, IL, 60610, US

(21) Appl. No.: 12/327,097

(22) Filed: Dec. 3, 2008

(30) Foreign Application Priority Data
Dec. 6, 2007 (JP) JP2007-315459
Nov. 10, 2008 (JP) JP2008-288088

(51) Int. Cl. H02J 7/04

(52) U.S. Cl. 320/134

(57) ABSTRACT

Provided is a battery state monitoring circuit for manufacturing a battery device at low cost, and a battery device including the same. A charge control transistor and a discharge control transistor are structured so as to be operated based on a low-level signal which is based on a ground voltage (VSS) and a high-level signal which is based on a voltage of a voltage regulator, which is lower than a power supply voltage (VDD) based on a voltage of a battery, respectively. Accordingly, in the charge control transistor and the discharge control transistor, voltages applied to gates thereof become low, whereby a low-breakdown-voltage element can be used. This leads to a reduction in cost for the charge control transistor and the discharge control transistor, leading to a reduction in manufacturing cost for the battery device.

### RELATED APPLICATIONS

This application claims priority under 35 U.S.C. §119 to Japanese Patent Application Nos. JP2007-315459 filed on Dec. 6, 2007 and JP2008-288088 filed on Nov. 10, 2008, the entire contents of which are hereby incorporated by reference.

### BACKGROUND OF THE INVENTION

1. Field of the Invention

The present invention relates to a battery state monitoring circuit for monitoring battery states of a plurality of batteries, and a battery device including the battery state monitoring circuit.

2. Description of the Related Art

There is described a conventional battery device. FIG. 2 is a block diagram illustrating the battery device.

A battery state monitoring circuit 60 monitors a state of a battery 71. A detector circuit 61 detects an overcharged state and an overdischarged state of the battery 71. When a signal is input from the detector circuit 61, a delay circuit 62 outputs the received signal after a lapse of a predetermined delay time. A control circuit 64 is operated so that a charge path is cut off at a predetermined time. When a charge control transistor 81 is turned off, the charge path ranging from a charger (not shown) to the battery 71 is cut off. Further, the control circuit 64 is operated so that a discharge path is cut off at a predetermined time. When a discharge control transistor 82 is turned off, the discharge path ranging from the battery 71 to a load (not shown) is cut off (for example, see JP 2007-195303 A).

In FIG. 2, the battery device includes one battery, but includes a plurality of batteries in some cases. In such a case, a voltage supplied to the control circuit 64 as power is a power supply voltage VDD which is based on voltages of the plurality of batteries, and the control circuit 64 outputs a high-level signal based on the power supply voltage VDD and a low-level signal based on a ground voltage VSS to gates of the charge control transistor 81 and the discharge control transistor 82.

Further, circuits of the charge control transistor 81 and the discharge control transistor 82 are designed based on breakdown voltages applied to the gates thereof.

Therefore, the charge control transistor 81 and the discharge control transistor 82 are formed of an element having a high breakdown voltage because voltages applied to the gates thereof become high. Consequently, there arises a problem that manufacturing costs for the charge control transistor 81 and the discharge control transistor 82 are increased, leading to an increase in manufacturing cost for the battery device.

### SUMMARY OF THE INVENTION

The present invention has been made in view of the above-mentioned circumstances, and therefore an object thereof is to provide a battery state monitoring circuit for reducing manufacturing cost for a battery device, and a battery device including the same.

In order to solve the above-mentioned problem, the present invention provides a battery state monitoring circuit, including: a detector circuit for detecting charge/discharge states of a plurality of batteries to output a detection signal indicating the charge/discharge states thereof; a delay circuit for receiving input of the detection signal to output the detection signal after a lapse of a predetermined delay time; a voltage regulator for receiving input of a power supply voltage based on voltages of the plurality of batteries to output a constant voltage lower than the power supply voltage; and a control circuit for outputting, when the detection signal is input, a low-level signal based on a ground voltage and a high-level signal based on the constant voltage output by the voltage regulator to a gate of a charge control transistor and a gate of a discharge control transistor, respectively.

Further, the present invention provides a battery device including the battery state monitoring circuit.

In the present invention, the charge control transistor and the discharge control transistor are operated based on the high-level signal which is based on the output voltage of the voltage regulator, which is lower than the power supply voltage based on the voltages of the plurality of batteries. Accordingly, lower voltages are applied to the gates of the charge control transistor and the discharge control transistor, whereby a low-breakdown-voltage element can be used. As a result, manufacturing costs for the charge control transistor and the discharge control transistor are reduced, leading to a reduction in manufacturing cost for the battery device.

### BRIEF DESCRIPTION OF THE DRAWINGS

In the accompanying drawings:

FIG. 1 is a block diagram illustrating a battery device according to the present invention; and

FIG. 2 is a block diagram illustrating a conventional battery device.

### DETAILED DESCRIPTION OF THE PREFERRED EMBODIMENT

Hereinafter, an embodiment of the present invention is described with reference to the drawings.

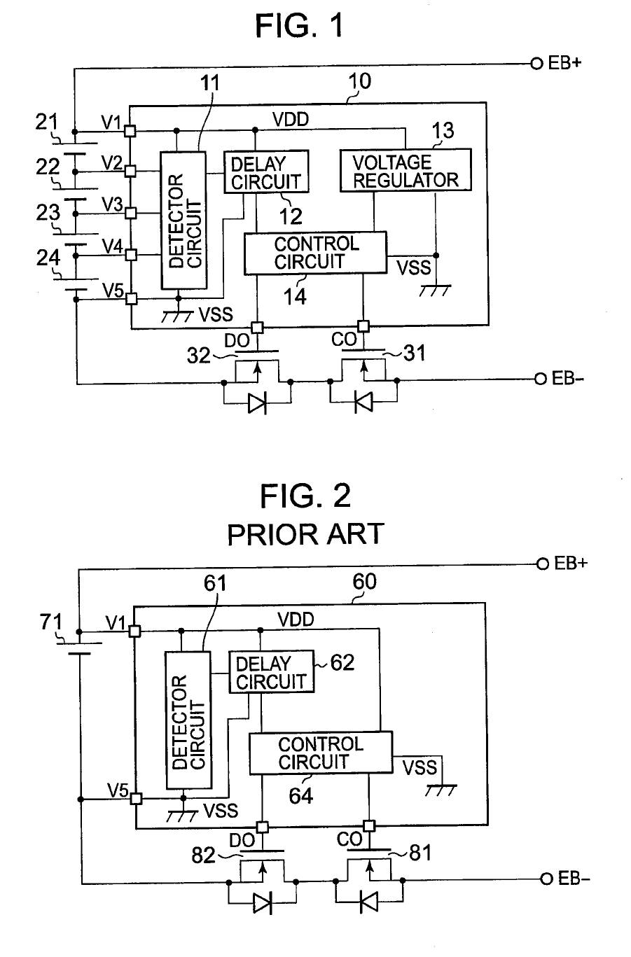

First, the structure of a battery device is described. FIG. 1 is a block diagram illustrating the battery device.

The battery device includes batteries 21 to 24, a battery state monitoring circuit 10, a charge control NMOS transistor 31, and a discharge control NMOS transistor 32. Besides, the battery device includes an external terminal EB+ and an external terminal EB−.

The battery state monitoring circuit 10 includes a detector circuit 11, a delay circuit 12, a voltage regulator 13, and a control circuit 14. In addition, the battery state monitoring circuit 10 includes monitor terminals V1 to V5, a control terminal CO, and a control terminal DO.

The batteries 21 to 24 are connected in series with each other, the battery 21 is connected to the external terminal EB+, and the battery 24 is connected to the discharge control NMOS transistor 32. A + terminal of the battery 21 is connected to the monitor terminal V1, a + terminal of the battery 22 is connected to the monitor terminal V2, a + terminal of the battery 23 is connected to the monitor terminal V3, a + terminal of the battery 24 is connected to the monitor terminal V4, and a − terminal of the battery 24 is connected to the monitor terminal V5. The charge control NMOS transistor 31 is provided between the discharge control NMOS transistor 32 and the external terminal EB−. A gate of the charge control NMOS transistor 31 is connected to the control terminal CO, and a gate of the discharge control NMOS transistor 32 is connected to the control terminal DO.

The detector circuit 11 is connected to the monitor terminals V1 to V5 and the delay circuit 12. The delay circuit 12 is connected to the monitor terminal V1, the monitor terminal V5, and the control circuit 14. The voltage regulator 13 is connected to the monitor terminal V1, the monitor terminal V5, and the control circuit 14. The control circuit 14 is connected to the monitor terminal V5, the control terminal CO, and the control terminal DO.

Here, the battery state monitoring circuit 10 monitors states of the batteries 21 to 24. The detector circuit 11 detects overcharged states and overdischarged states of the batteries 21 to 24. When a signal is input from the detector circuit 11, the delay circuit 12 outputs the received signal after a lapse of a predetermined delay time. The voltage regulator 13 outputs a constant output voltage. The control circuit 14 is operated so as to cut off a charge path at a predetermined time. When being turned off, the charge control NMOS transistor 31 cuts off the charge paths ranging from a charger (not shown) to the batteries 21 to 24. The control circuit 14 is operated so as to cut off a discharge path at a predetermined time. When being turned off, the discharge control NMOS transistor 32 cuts off the discharge paths ranging from the batteries 21 to 24 to a load (not shown).

A circuit is designed so that an output voltage of the voltage regulator 13 is lower than breakdown voltages of the charge control NMOS transistor 31 and the discharge control NMOS transistor 32.

Next, an operation of the battery device is described.

(Case where the charger charges the battery and the battery enters the overcharged state) The charger is connected to the battery device, and charging is started. The voltage regulator 13 outputs a constant output voltage lower than the power supply voltage VDD, based on the power supply voltage VDD which is based on the voltages of the batteries 21 to 24.

When any one of the batteries 21 to 24 enters the overcharged state, the detector circuit 11 detects the overcharged state of the relevant battery to output an overcharging detection signal indicating the overcharged state to the delay circuit 12. The delay circuit 12 outputs the overcharging detection signal to the control circuit 14 after a lapse of a predetermined delay time. Then, the control circuit 14 outputs a high-level signal based on the output voltage of the voltage regulator 13 to the gate of the discharge control NMOS transistor 32, whereby the discharge control NMOS transistor 32 is turned on. Further, the control circuit 14 outputs a low-level signal based on the ground voltage VSS to the gate of the charge control NMOS transistor 31, whereby the charge control NMOS transistor 31 is turned off. When the charge control NMOS transistor 31 is turned off, a discharge current flows by means of a parasitic diode, but a charge current does not flow. Accordingly, the charge paths ranging from the charger to the batteries 21 to 24 are cut off, whereby charging is prohibited.

(Case where the battery is discharged through the load, and the battery enters the overdischarged state) The load is connected to the battery device, whereby discharging is started. The voltage regulator 13 outputs a constant output voltage lower than the power supply voltage VDD, based on the power supply voltage VDD which is based on the voltages of the batteries 21 to 24.

When any one of the batteries 21 to 24 enters the overdischarged state, the detector circuit 11 detects the overdischarged state of the relevant battery to output an overdischarging detection signal indicating the overdischarged state to the delay circuit 12. The delay circuit 12 outputs the overdischarging detection signal to the control circuit 14 after a lapse of a predetermined delay time. Then, the control circuit 14 outputs the high-level signal to the gate of the charge control NMOS transistor 31, whereby the charge control NMOS transistor 31 is turned on. Further, the control circuit 14 outputs the low-level signal to the gate of the discharge control NMOS transistor 32, whereby the discharge control NMOS transistor 32 is turned off. When the discharge control NMOS transistor 32 is turned off, the charge current flows by means of the parasitic diode, but the discharge current does not flow. Accordingly, the discharge paths ranging from the batteries 21 to 24 to the load are cut off, whereby discharging is prohibited.

Through the operation mentioned above, the charge control NMOS transistor 31 and the discharge control NMOS transistor 32 are operated not based on the power supply voltage VDD which is based on the voltages of the batteries 21 to 24, but based on the high-level signal which is based on the output voltage of the voltage regulator 13 and the low-level signal which is based on the ground voltage VSS. Accordingly, in the charge control NMOS transistor 31 and the discharge control NMOS transistor 32, voltages applied to the gates thereof become low, whereby the breakdown voltages thereof can be low, and the high-breakdown-voltage element may not be necessarily used. Consequently, manufacturing costs for the charge control NMOS transistor 31 and the discharge control NMOS transistor 32 are reduced, leading to a reduction in manufacturing cost for the battery device.

Further, the control circuit 14 is supplied not with the power supply voltage VDD, but with the output voltage of the voltage regulator 13, and thus a voltage supplied thereto as power is reduced. As a result, the control circuit 14 can have a low breakdown voltage, and the high-breakdown-voltage element may not be necessarily used, resulting in a reduction in area thereof. Further, the control circuit 14 is supplied with a lower voltage as power, leading to a less power consumption.

Further, the voltages applied to the gates of the charge control NMOS transistor 31 and the discharge control NMOS transistor 32 are the output voltages of the voltage regulator 13, which are constant. Accordingly, on-resistances of the charge control NMOS transistor 31 and the discharge control NMOS transistor 32 become constant.

Further, the voltages applied to the gates of the charge control NMOS transistor 31 and the discharge control NMOS transistor 32 are the output voltages of the voltage regulator 13, which are lower than the breakdown voltages of the charge control NMOS transistor 31 and the discharge control NMOS transistor 32. Accordingly, there is no need to provide the battery device with a part for protecting the breakdown voltages of the charge control NMOS transistor 31 and the discharge control NMOS transistor 32, leading to a reduction in manufacturing cost for the battery device.

It should be noted that the element which cuts off the charge path and the element which cuts off the discharge path are the charge control NMOS transistor 31 and the discharge control NMOS transistor 32 provided between the battery 24 and the external terminal EB−, respectively, but may be a charge control PMOS transistor (not shown) and a discharge control PMOS transistor (not shown) provided between the battery 21 and the external terminal EB+, respectively. Here, the control circuit 14 is appropriately designed so that the gates of the charge control NMOS transistor 31 and the discharge control NMOS transistor 32 are applied with a voltage between the output voltage of the voltage regulator 13 and the ground voltage VSS, and that gates of the charge control PMOS transistor (not shown) and the discharge control PMOS transistor (not shown) are applied with a voltage between the power supply voltage VDD and the output voltage of the voltage regulator 13.

Further, the voltage supplied to the delay circuit 12 as power is the voltage between the power supply voltage VDD and the ground voltage VSS, but may be a voltage between the output voltage of the voltage regulator 13 and the ground voltage VSS or may be a voltage between the power supply voltage VDD and the output voltage of the voltage regulator 13.

As a result, in the delay circuit 12, a voltage supplied as power becomes low, and thus the breakdown voltage thereof can be low, and the high-breakdown-voltage element may not be necessarily used, leading to a reduction in area thereof. Further, in the delay circuit 12, the voltage supplied as power becomes low, leading to a reduction in power consumption.

Further, the number of the batteries provided in the battery device is four, but may be less than four or equal to or more than five.

Further, the battery state monitoring circuit 10 is formed of one semiconductor device, and the charge control NMOS transistor 31 and the discharge control NMOS transistor 32 are formed of a field effect transistor (FET). However, the battery state monitoring circuit 10, the charge control NMOS transistor 31, and the discharge control NMOS transistor 32 may be formed of one semiconductor device.

What is claimed is:

1. A battery state monitoring circuit for monitoring battery states of a plurality of batteries connected in series with each other, comprising:
a detector circuit for detecting charge/discharge states of the plurality of batteries to output a detection signal indicating the charge/discharge states thereof;
a delay circuit for receiving input of the detection signal to output the detection signal after a lapse of a predetermined delay time;
a voltage regulator for receiving input of a power supply voltage based on voltages of the plurality of batteries to output a constant voltage lower than the power supply voltage; and
a control circuit for outputting, when the detection signal is input, a low-level signal based on a ground voltage and a high-level signal based on the constant voltage output by the voltage regulator to a gate of a charge control transistor and a gate of a discharge control transistor, respectively.

2. A battery device, comprising:
a plurality of batteries;
a charge control transistor;
a discharge control transistor; and
the battery state monitoring circuit according to claim 1, for monitoring charge/discharge states of the plurality of batteries to control the charge control transistor and the discharge control transistor.
